(19) United States
(12) Patent Application Publication
(10) Pub. No.: US 2017/0031563 A1
(43) Pub. Date: Feb. 2, 2017

(54) METHOD AND APPARATUS FOR DISPLAY CONTROL AND ELECTRONIC DEVICE

(71) Applicants: BEIJING LENOVO SOFTWARE LTD., Beijing (CN); LENOVO (BEIJING) LIMITED, Beijing (CN)

(72) Inventors: Shoupeng ZHANG, Beijing (CN); Yang YANG, Beijing (CN); Xiaohai ZHANG, Beijing (CN); Li DING, Beijing (CN)

(73) Assignees: LENOVO (BEIJING) LIMITED, Beijing (CN); BEIJING LENOVO SOFTWARE LTD., Beijing (CN)

(21) Appl. No.: 14/934,443

(22) Filed: Nov. 6, 2015

(30) Foreign Application Priority Data
Jul. 27, 2015 (CN) 201510447166.2

(51) Int. Cl. G06F 3/0481; G06F 3/0482

(52) U.S. Cl. CPC G06F 3/04817; G06F 3/0482

(57) ABSTRACT

The present disclosure provides a method and an apparatus for display control as well as an electronic device. The method comprises: loading a desktop application, the desktop application having an interaction interface including a plurality of folders; obtaining a first input operation on an icon of a first folder on the interaction interface currently displayed on the display screen; generating, in response to the first input operation, an invocation instruction; activating the folder manager in response to the invocation instruction; obtaining all folders in the electronic device with the folder manager; setting all the folders to an unfolded state; displaying the folders in the unfolded state in a queue on the display screen.

### TECHNICAL FIELD

The present disclosure relates to electronics technology, and more particularly, to methods and apparatuses for display control as well as electronic devices.

### BACKGROUND

Desktop application is an application (APP) that facilitates a user's management of icons of applications installed in an electronic device. A desktop application typically includes icons of applications in folders. By clicking on an icon of a folder, a user can unfold the folder and view merely the icons included in the folder. When none of the icons included in the folder is the icon representing an application desired by the user, the user has to go back to the desktop from the unfolded folder, find an icon of another folder on the desktop and unfold the other folder to search the desired application. This is inefficient and inconvenient.

### SUMMARY

In order to solve at least one of the above problems, embodiments of the present disclosure provide a method and an apparatus for display control as well as an electronic device, capable of browsing icons in a folder quickly and thereby improving user experience.

In a first aspect, according to an embodiment of the present disclosure, a method for display control is provided. The method comprises: loading a desktop application having an interaction interface, wherein the interaction interface includes a plurality of folders and is displayed on a display screen of an electronic device; obtaining a first input operation on an icon of a first folder on the interaction interface currently displayed on the display screen; generating, in response to the first input operation, an invocation instruction for activating a folder manager; activating the folder manager in response to the invocation instruction; obtaining all folders in the electronic device with the folder manager; setting all the folders to an unfolded state; and displaying the folders in the unfolded state in a queue on the display screen.

In a second aspect, according to another embodiment of the present disclosure, an apparatus for display control is provided. The apparatus comprises: a loading unit configured to load a desktop application having an interaction interface, wherein the interaction interface includes a plurality of folders and is displayed on a display screen of an electronic device; a first obtaining unit configured to obtain a first input operation on an icon of a first folder on the interaction interface currently displayed on the display screen; a first responding unit configured to generate, in response to the first input operation, an invocation instruction for activating a folder manager; a second responding unit configured to activate the folder manager in response to the invocation instruction; a second obtaining unit configured to obtain all folders in the electronic device with the folder manager; a first processing unit configured to set all the folders to an unfolded state; and a first display unit configured to display the folders in the unfolded state in a queue on the display screen.

In a third aspect, according to yet another embodiment of the present disclosure, an electronic device is provided. The electronic device comprises: a display screen configured to display a display interface of a folder; and a processor configured to: load a desktop application having an interaction interface, wherein the interaction interface includes a plurality of folders and is displayed on the display screen of the electronic device; obtain a first input operation on an icon of a first folder on the interaction interface currently displayed on the display screen; generate, in response to the first input operation, an invocation instruction for activating a folder manager; activate the folder manager in response to the invocation instruction; obtain all folders in the electronic device with the folder manager; set all the folders to an unfolded state; and display the folders in the unfolded state in a queue on the display screen.

According to the embodiments of the present disclosure, a desktop application is loaded. The desktop application has an interaction interface including a plurality of folders and displayed on a display screen of an electronic device. A first input operation on an icon of a first folder on the interaction interface currently displayed on the display screen is obtained. In response to the first input operation, an invocation instruction for activating a folder manager is generated. The folder manager is activated in response to the invocation instruction. All folders in the electronic device are obtained with the folder manager. All the folders are set to an unfolded state. The folders in the unfolded state are displayed in a queue on the display screen. When a plurality of icons included in each of all the folders cannot be displayed within one page on a display interface associated with each of all the folders in accordance with a standard parameter, the plurality of icons are processed to obtain a specific parameter based on the standard parameter. The specific parameter enables each of all the folders to display all the icons it includes within one page on its display interface. The plurality of icons included in each folder are displayed on the display interface associated with the folder in accordance with the specific parameter. In this way, it is possible to browse icons in a folder quickly and thereby improving user experience.

### BRIEF DESCRIPTION OF THE DRAWINGS

FIG. 1A is a flowchart illustrating a method for display control according to a first embodiment of the present disclosure;

FIG. 1B is a first schematic diagram showing a display interface in a queue form according to the first embodiment of the present disclosure;

FIG. 1C is a second schematic diagram showing a display interface in a queue form according to the first embodiment of the present disclosure;

FIG. 1D is a third schematic diagram showing a display interface in a queue form according to the first embodiment of the present disclosure;

FIG. 1E is a schematic diagram showing a display interface where icons are displayed in accordance with a standard parameter according to the first embodiment of the present disclosure;

FIG. 1F is a schematic diagram showing icons according to the first embodiment of the present disclosure;

FIG. 2 is a flowchart illustrating a method for display control according to a second embodiment of the present disclosure;

FIG. 3A is a flowchart illustrating a method for display control according to a third embodiment of the present disclosure;

FIG. 3B is a schematic diagram showing a scenario according to the third embodiment of the present disclosure;

FIG. 4 is a flowchart illustrating a method for display control according to a fourth embodiment of the present disclosure;

FIG. 5 is a flowchart illustrating a method for display control according to a fifth embodiment of the present disclosure; and

FIG. 6 is a block diagram showing configuration of an apparatus for display control according to a sixth embodiment of the present disclosure.

### DETAILED DESCRIPTION OF THE EMBODIMENTS

In the following, the solutions of the present disclosure will be described in detail with reference to the figures and embodiments.

### First Embodiment

According to an embodiment of the present disclosure, a method for display control is provided. The method is applied in an electronic device. The method can be implemented by a processor in the electronic device executing program codes. The program codes can be stored in a computer storage medium. That is, the electronic device includes at least the processor and the storage medium.

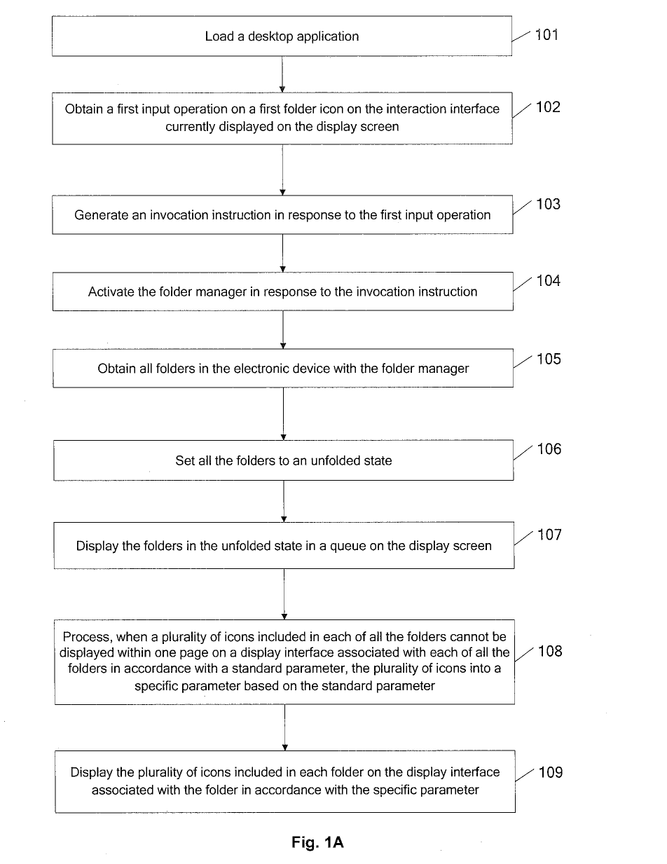

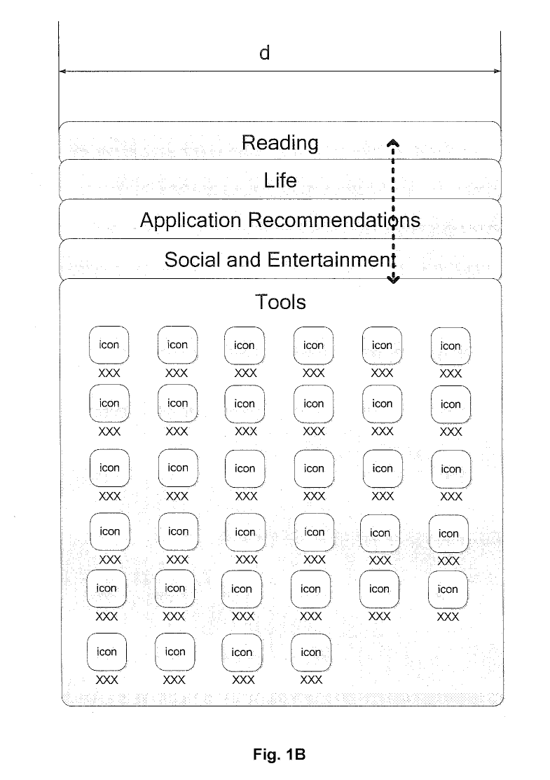

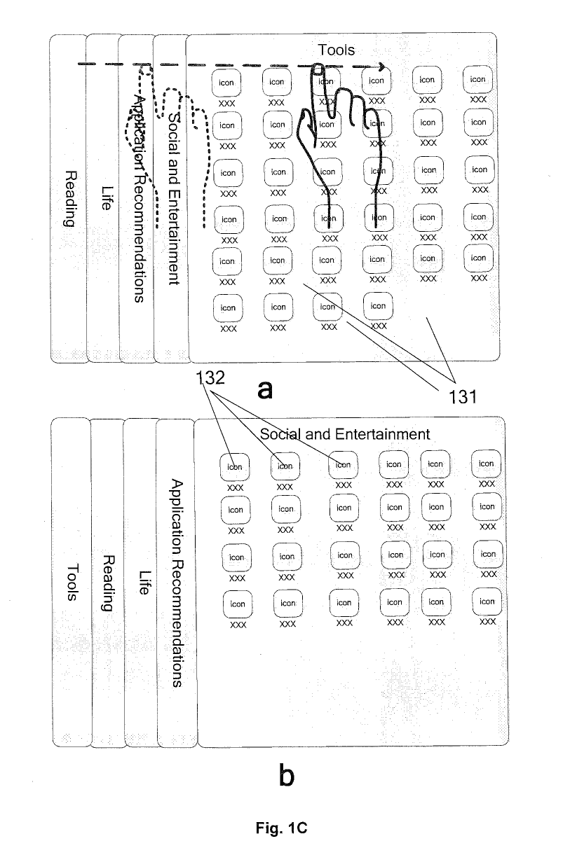

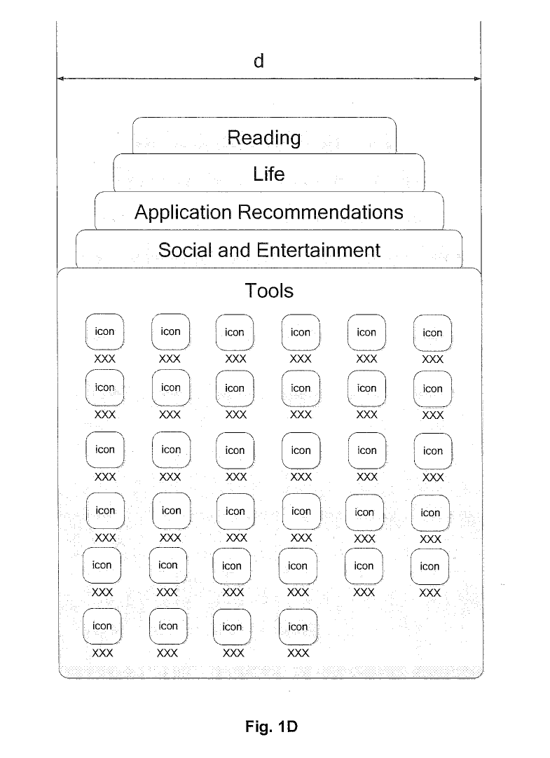

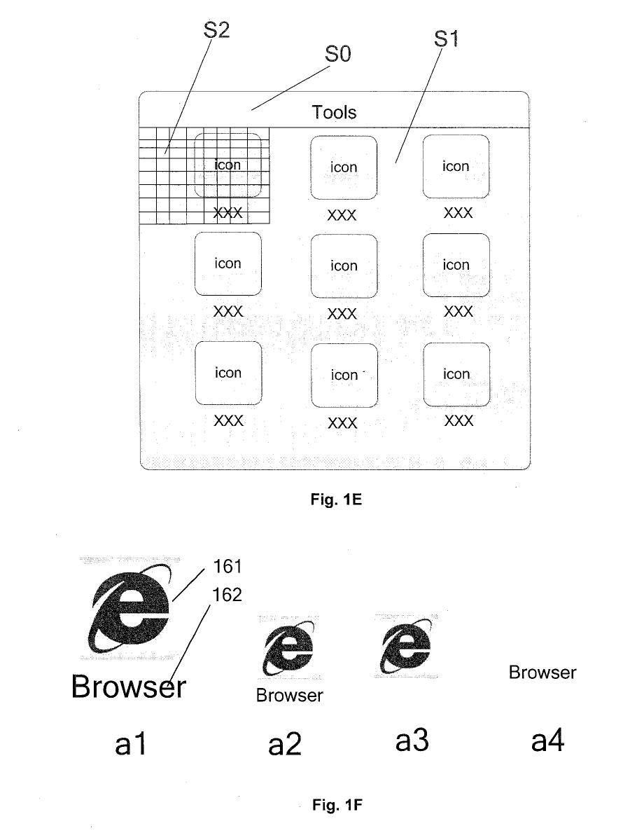

FIG. 1A is a flowchart illustrating a method for display control according to a first embodiment of the present disclosure. As shown in FIG. 1A, the method for display control includes the following steps.

At step 101, a desktop application is loaded.

Here, the desktop application has an interaction interface including a plurality of folders and being displayed on a display screen of an electronic device.

Here, the electronic device can be a fixed electronic device, such as a Personal Computer (PC), a portable electronic device, such as a Personal Digital Assistant (PDA), a tablet computer or a laptop computer, or a smart mobile terminal such as a smart phone.

At step 102, a first input operation on an icon of a first folder on the interaction interface currently displayed on the display screen is obtained.

Here, the icon of the first folder may be an identifier of the first folder in the form of an icon, and the first folder may be any of the folders included in the desktop application.

Here, the first input operation may vary depending on the type of the electronic device. For example, when the electronic device is a general PC and an input device is a mouse, the first input operation may be a mouse click operation by a user on the display screen. When the display device of the electronic device is a touch-sensitive display screen (e.g., a smart phone, tablet computer or a desktop computer may have a touch screen), the first input operation may be a touch operation by an operator, which can be a finger or a stylus. It is to be noted that the first input operation may be various operations as can be appreciated by those skilled in the art. For example, the first input operation may include an operation where the user clicks the icon of the first folder using a mouse, or an operation where the user touches the icon of the first folder with his/her finger. The implementation of the present disclosure is not limited to this embodiment. Alternative implementations of the first input operation can be appreciated by those skilled in the art and thus description thereof will be omitted here. It can be seen from above that, in addition to the display screen, the electronic device has an input device, which can be integrated with the display screen when a touch-sensitive display screen (touch screen) is provided in the electronic device.

At step 103, in response to the first input operation, an invocation instruction is generated.

Here, the invocation instruction is used for activating a folder manager.

At step 104, the folder manager is activated in response to the invocation instruction.

Here, the folder manager is used for managing all folders in the electronic device, including states of the folders, the number of icons that can be displayed within each folder, sizes of the folders and the like.

Here, the states of the folders include a foreground state and a background state. When a folder is in the foreground state, it is active and is set to an unfolded state by the folder manager. In the unfolded state, all the icons in the folder can be viewed by the user. When a folder is in the background state, it is inactive and is obstructed by other folders. In other words, the folder is in a closed state where the icons in the folder cannot be viewed by the user.

At step 105, all folders in the electronic device are obtained with the folder manager.

Here, when the desktop application is installed in the electronic device, it can categorize the icons of all the objects to be managed in the electronic device in folders. Here, the icons of the objects to be managed in the electronic device include icons of applications, folders, files and the like. It is to be noted that, when the desktop application is applied in a mobile phone or a tablet computer, the objects to be managed by the desktop application are mainly icons of applications.

At step 106, all the folders are set to an unfolded state.

At step 107, the folders in the unfolded state are displayed in a queue on the display screen.

At step 108, when a plurality of icons included in each of all the folders cannot be displayed within one page on a display interface associated with each of all the folders in accordance with a standard parameter, the plurality of icons are processed to obtain a specific parameter based on the standard parameter.

Here, the specific parameter enables each of all the folders to display all the icons it includes within one page on its display interface. In an exemplary implementation, the specific parameter can be obtained by scaling down the standard parameter. For example, the areas of the icons can be scaled down, or only some of the icons can be displayed selectively, such that the icons can be displayed within one page. Generally, as shown in FIG. 1F, an icon includes an image 161 and a descriptive text 162 that can indicate the application or file. Here, the descriptive text 162 is typically the name of the object associated with the icon. For example, “Browser” 162 is the name of the browser application. FIG. 1F includes four graphs, of which Graph a1 is a schematic diagram for the standard parameter, Graph a2 is a schematic diagram showing a scaled down Graph a1, Graph a3 is a schematic diagram showing the image 161 that is selectively displayed, and Graph a4 is a schematic diagram showing the descriptive text 162 that is selectively displayed.

Here, the standard parameter can include a first area which is an area of a display region of each icon, and a first number which is a number of icons displayed on the display interface. As shown in FIG. 1E, assuming the area in the folder display interface for displaying icons to be S1 and the number of object icons that can be displayed within one display interface is N, the area occupied by each object icon is S2=S1/N, where S2 is the area of the shaded region.

At step 109, the plurality of icons included in each folder are displayed on the display interface associated with the folder in accordance with the specific parameter.

In an embodiment of the present disclosure, the method further includes a step, corresponding to the step 108, of: directly displaying the plurality of icons when the plurality of icons can be displayed within one page on the display interface associated with the first folder in accordance with the standard parameter.

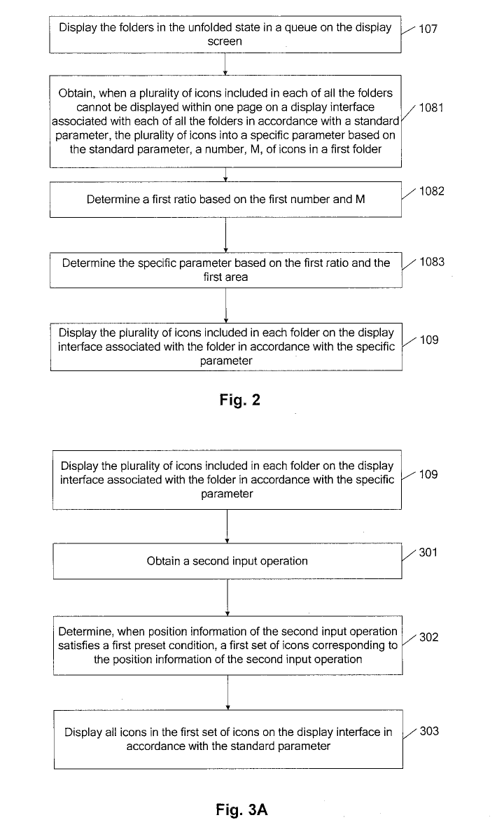

In an embodiment of the present disclosure, there may be one, two or even more pages for displaying a folder and the number of pages for displaying the icons in the folder depends on the standard parameter. For the “Tools” folder shown in FIG. 1-2 as an example, it includes 34 icons in total. Assuming the first number in the standard parameter is 9 (see FIG. 1E), the number of icons in the folder that can be displayed within one page is 9. In this case, the icons in the “Tools” folder can be displayed in four pages in accordance with the standard parameter. Hence, in the step 101, if there is only one page of icons in the folder, the first page of the interaction display can be displayed on the display screen; otherwise if there are two or more pages of icons in the folder, a part (e.g., the first page) of the interaction interface can be displayed on the display screen and can be switched to another part (e.g., the second page) with a switching operation.

The queue form in which the folders are displayed in the step 107 will be explained below. FIG. 1B is a first schematic diagram showing a display interface in a queue form according to the first embodiment of the present disclosure. As shown in FIG. 1B, it is assumed that there are five folders in total in the electronic device, whose names are Tools, Social and Entertainment, Application Recommendations, Life and Reading, respectively. These five folders are presented to the user in a queue from top to bottom. In the current page, the icons in the Tools folder are presented to the user first. When the user slides up and down, the icons in the Social and Entertainment folder are placed at the top of the queue and the icons in the Tools folder are placed at the bottom of the queue, i.e., the Social and Entertainment folder is presented to the user. If the user continues sliding up and down, the icons in the Application Recommendations folder are placed at the top of the queue and the icons in the Social and Entertainment folder are placed at the bottom of the queue, i.e., the Application Recommendations folder is presented to the user. In this way, the user can view up to the Reading folder by sliding up and down.

FIG. 1C is a second schematic diagram showing a display interface in a queue form according to the first embodiment of the present disclosure. As shown in FIG. 1C, it is assumed again that there are five folders in total in the electronic device, whose names are Tools, Social and Entertainment, Application Recommendations, Life and Reading, respectively. These five folders are presented to the user in a queue from left to right. In the current page, the icons in the Tools folder are presented to the user first. When the user slides left and right (see Graph a of FIG. 1C), the icons in the Social and Entertainment folder are placed at the top of the queue and the icons in the Tools folder are placed at the bottom of the queue (see Graph b of FIG. 1C), i.e., the Social and Entertainment folder is presented to the user. If the user continues sliding left and right, the icons in the Application Recommendations folder are placed at the top of the queue and the icons in the Social and Entertainment folder are placed at the bottom of the queue, i.e., the Application Recommendations folder is presented to the user. In this way, the user can view up to the Reading folder by sliding left and right.

FIG. 1D is a third schematic diagram showing a display interface in a queue form according to the first embodiment of the present disclosure. As shown in FIG. 1D, five folders are presented to the user in a queue from top to bottom. Unlike FIG. 1B, the width of the folder at the bottom of the queue is wider than that of its upper folder. That is, in FIG. 1D, the width of each icon in the Social and Entertainment folder is smaller than the width, d, of each icon in the Tools folder; the width of each icon in the Application Recommendations folder is smaller than the width of each icon in the Social and Entertainment folder, the width of each icon in the Life folder is smaller than the width of each icon in the Application Recommendations folder, and the width of each icon in the Reading folder is smaller than the width of each icon in the Life folder. In contrast, in FIG. 1B, the width of each folder in the queue is d. The presentation of the queue as shown in FIG. 1D is the same as that in FIG. 1B in that the icons in the folders are presented from top to bottom, i.e., along Z-axis in 3D Cartesian coordinate system. However, unlike FIG. 1B, the presentation shown in FIG. 1D provides the user with a perception that the icons of the folders are extended in Z-axis, which complies with a 3D space where, even if all objects have the same physical dimensions, the viewer will perceive a smaller size of an object when it is farther away from the viewer. In other words, the presentation shown in FIG. 1D provides a perception closer to that in the real-world 3D space.

It is to be noted that, in FIGS. 1B, 1C and 1D, only the folder presented at the top of the queue is active and the folders at lower positions in the queue are inactive. For an inactive folder, only an icon of the folder is presented and the icons in the folder are disabled. For example, as shown in FIG. 1B, when the Social and Entertainment folder is inactive, the icons of the applications in the folder are disabled such that the user cannot activate the applications in the folder. When the Tools folder is active, the icons of the applications in the folder are enabled and the user can activate an application in the folder by clicking its icon.

### Second Embodiment

Based on the above first embodiment, a method for display control is provided according to an embodiment of the present disclosure. The method is applied in an electronic device. The method can be implemented by a processor in the electronic device executing program codes. The program codes can be stored in a computer storage medium. That is, the electronic device includes at least the processor and the storage medium.

In an embodiment of the present disclosure, the standard parameter includes a first area which is an area of a display region of each icon, and a first number which is a number of icons displayed on the display interface, i.e., the number of icons that can be displayed within one page in a folder.

FIG. 2 is a flowchart illustrating a method for display control according to a second embodiment of the present disclosure. As shown in FIG. 2, the method for display control includes the following steps.

At step 101, a desktop application is loaded.

Here, the desktop application has an interaction interface including a plurality of folders and displayed on a display screen of an electronic device.

At step 102, a first input operation on an icon of a first folder on the interaction interface currently displayed on the display screen is obtained.

Here, the icon of the first folder is an identifier of a first folder in the form of an icon, and the first folder can be any of the folders included in the desktop application.

At step 103, in response to the first input operation, an invocation instruction is generated.

Here, the invocation instruction is used for activating a folder manager.

At step 104, the folder manager is activated in response to the invocation instruction.

At step 105, all folders in the electronic device are obtained with the folder manager.

Here, when the desktop application is installed in the electronic device, it can categorize the icons of all the objects to be managed in the electronic device in folders. Here, the icons of the objects to be managed in the electronic device include icons of applications, folders, files and the like. It is to be noted that, when the desktop application is applied in a mobile phone or a tablet computer, the objects to be managed by the desktop application are mainly icons of applications.

At step 106, all the folders are set to an unfolded state.

At step 107, the folders in the unfolded state are displayed in a queue on the display screen.

At step 1081, when a plurality of icons included in each of all the folders cannot be displayed within one page on a display interface associated with each of all the folders in accordance with a standard parameter, a number, M, of icons in a first folder is obtained.

Here, M is an integer larger than or equal to zero. When the number, M, of the icons in the first folder cannot be displayed within one page, M is larger than the first number. On the other hand, when the number, M, of the icons in the first folder can be displayed within one page, M is smaller than or equal to the first number. In an embodiment of the present disclosure, the icons can be icons of files, applications, folders and the like.

At step 1082, a first ratio is determined based on the first number and M.

Here, in an implementation, the first ratio can be user-defined based on the first number and M in accordance with certain rule (e.g., represented by an equation). For example, the first ratio can be obtained by dividing the first number by M, i.e., the first ratio can be a ratio by which the first area in the standard parameter is to be scaled down.

At step 1083, a specific parameter is determined based on the first ratio and the first area.

Here, the specific parameter is a product of the first ratio and the first area. The above steps 1081-1083 effectively provide a particular scheme for performing the step 108 in the above first embodiment to “process the plurality of icons into the specific parameter based on the standard parameter”.

At step 109, the plurality of icons included in each folder are displayed on the display interface associated with the folder in accordance with the specific parameter.

The steps 101-107 and 109 of the second embodiment correspond to the steps 101-107 and 109 of the first embodiment, respectively. Hence, the above steps 101-107 and 109 can be understood by those skilled in the art with reference to the above first embodiment and the description thereof will be omitted here for conciseness.

### Third Embodiment

Based on the above first embodiment, a method for display control is provided according to an embodiment of the present disclosure. The method is applied in an electronic device. The method can be implemented by a processor in the electronic device executing program codes. The program codes can be stored in a computer storage medium. That is, the electronic device includes at least the processor and the storage medium.

In an embodiment of the present disclosure, the standard parameter includes a first area which is an area of a display region of each icon, and a first number which is a number of icons displayed on the display interface, i.e., the number of icons that can be displayed within one page in a folder.

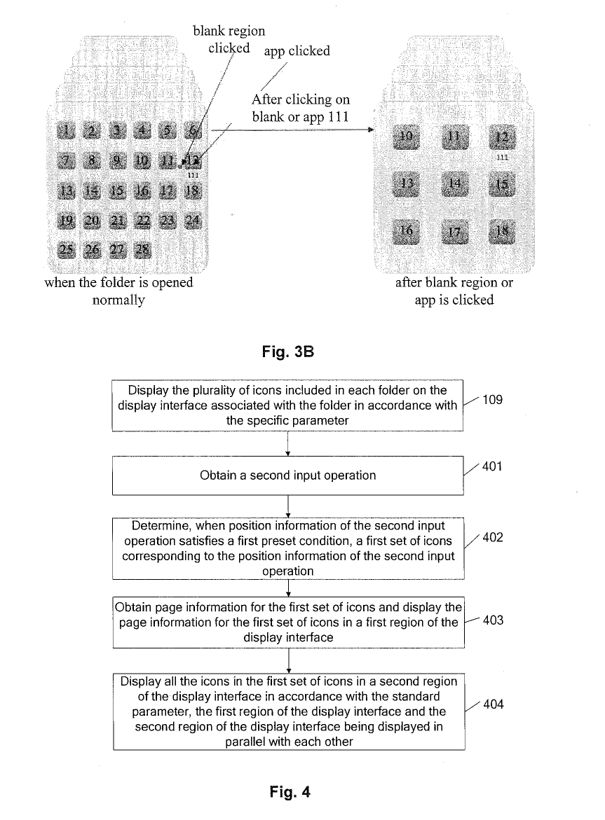

FIG. 3A is a flowchart illustrating a method for display control according to a third embodiment of the present disclosure. As shown in FIG. 3A, the method for display control includes the following steps.

At step 101, a desktop application is loaded.

Here, the desktop application has an interaction interface including a plurality of folders and displayed on a display screen of an electronic device.

At step 102, a first input operation on an icon of a first folder on the interaction interface currently displayed on the display screen is obtained.

Here, the icon of the first folder icon is an identifier of a first folder in the form of an icon, and the first folder can be any of the folders included in the desktop application.

At step 103, in response to the first input operation, an invocation instruction is generated.

Here, the invocation instruction is used for activating a folder manager.

At step 104, the folder manager is activated in response to the invocation instruction.

At step 105, all folders in the electronic device are obtained with the folder manager.

Here, when the desktop application is installed in the electronic device, it can categorize the icons of all the objects to be managed in the electronic device in folders. Here, the icons of the objects to be managed in the electronic device include icons of applications, folders, files and the like. It is to be noted that, when the desktop application is applied in a mobile phone or a tablet computer, the objects to be managed by the desktop application are mainly icons of applications.

At step 106, all the folders are set to an unfolded state.

At step 107, the folders in the unfolded state are displayed in a queue on the display screen.

At step 108, when a plurality of icons included in each of all the folders cannot be displayed within one page on a display interface associated with each of all the folders in accordance with a standard parameter, the plurality of icons are processed into a specific parameter based on the standard parameter.

At step 109, the plurality of icons included in each folder are displayed on the display interface associated with the folder in accordance with the specific parameter.

The steps 101-109 of the third embodiment correspond to the steps 101-109 of the first embodiment, respectively. Hence, the above steps 101-109 can be understood by those skilled in the art with reference to the above first embodiment and the description thereof will be omitted here for simplicity.

At step 301, a second input operation is obtained.

Here, the second input operation is similar to the first input operation in the above first embodiment and the description thereof will be omitted here.

At step 302, when position information of the second input operation satisfies a first preset condition, a first set of icons corresponding to the position information of the second input operation is determined.

Here, the position information of the second input operation can be determined, depending on the particular input device. When the input device is a mouse, the position information of the second input operation is the position information of the cursor of the mouse. When the input device is a touch display screen, the position information of the second input operation is the coordinate information of the contact point. In an implementation, the first condition can be set by those skilled in the art depending on actual situations. For example, the first condition can be the position information being at a blank region (each of the regions 131 as shown in FIG. 1C can be considered as a blank region). When the second input operation is at each of the regions 131, the position information of the second input operation can be determined to satisfy the first condition. Alternatively, the first condition can be an image of an icon (e.g., each of the regions 132 as shown in FIG. 1C). When the second input operation is at each of the regions 132, the position information of the second input operation can be determined to satisfy the first condition.

Here, the number of the icons in the first set of icons is smaller than or equal to the first number. Referring to FIG. 3B, there are 28 files in total in the Tools folder. Assuming that the first number in the standard parameter is 9, when the user clicks an icon 111 of an application, each of the icons numbered as 1-9 will be displayed on the first page of the folder display interface in the first area, each of the icons numbered as 10-18 will be displayed on the second page of the folder display interface in the first area, each of the icons numbered as 19-27 will be displayed on the third page of the folder display interface in the first area and the icon numbered as 28 will be displayed on the fourth page of the folder display interface in the first area. When the user clicks the icon numbered as 12, the first set of icons includes the icons numbered as 10-18. When the user clicks the icon numbered as 19, the first set of icons includes the icons numbered as 19-27. When the user clicks the icon numbered as 28, the first set of icons includes the icon numbered as 28.

At step 303, all icons in the first set of icons are displayed on the display interface in accordance with the standard parameter.

With the solution according to the embodiment of the present disclosure, when a folder is opened, it enters a folder list display mode where the folder is presented in a queue. When there are too many icons in the folder, i.e., when the number of icons in the folder is larger than the first number, the icons in the folder are scaled down such that all the icons in the folder can be displayed within one page. In an implementation, when the scaled icons are too small to be recognized, a lower limit threshold can be set for the scaled icons and all the icons can be displayed within one page in accordance with the lower limit threshold. When not all of the icons can be presented on the display interface, a horizontal scroll bar and a vertical scroll bar can be provided to facilitate the user's viewing.

### Fourth Embodiment

Based on the above first embodiment, a method for display control is provided according to an embodiment of the present disclosure. The method is applied in an electronic device. The method can be implemented by a processor in the electronic device executing program codes. The program codes can be stored in a computer storage medium. That is, the electronic device includes at least the processor and the storage medium.

In an embodiment of the present disclosure, the standard parameter includes a first area, which is an area of a display region of each icon, and a first number, which is a number of icons displayed on the display interface, i.e., the number of icons that can be displayed within one page in a folder.

In an embodiment of the present disclosure, the display interface includes a first region and a second region. Referring to FIG. 1E, the first region is the region marked as S0 and the second region is the region marked as S1. The first region is used for displaying the name of a folder and the second region is used for displaying icons in the folder.

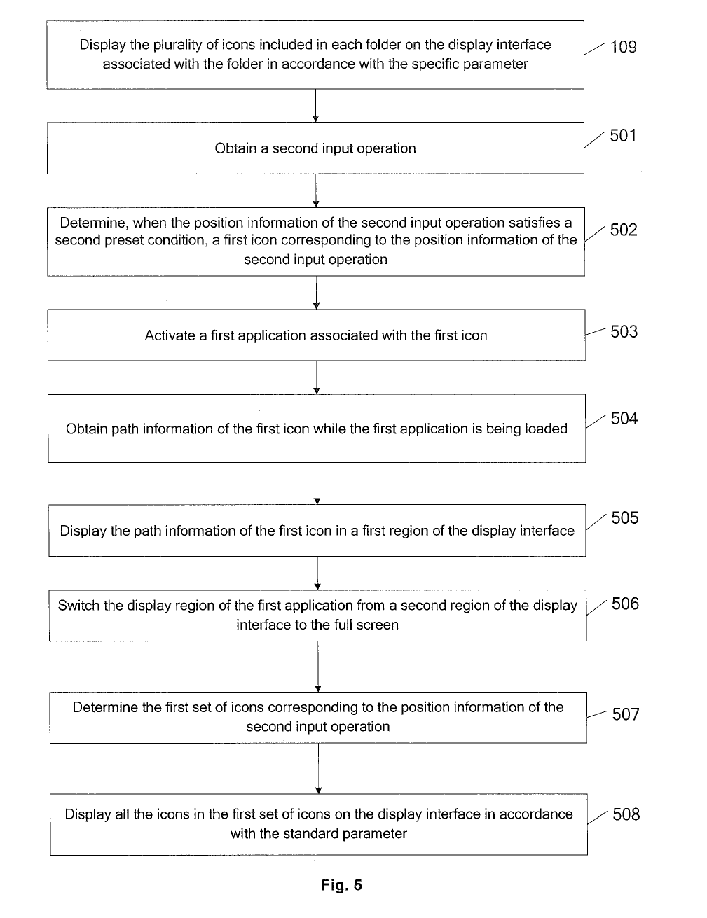

FIG. 4 is a flowchart illustrating a method for display control according to a fourth embodiment of the present disclosure. As shown in FIG. 4, the method for display control includes the following steps.

Steps 101-108 as described above.

At step 109, the plurality of icons included in each folder are displayed on the display interface associated with the folder in accordance with the specific parameter.

The steps 101-109 of the fourth embodiment correspond to the steps 101-109 of the first embodiment, respectively. Hence, the steps 101-109 in the fourth embodiment can be understood by those skilled in the art with reference to the above first embodiment and the description thereof will be omitted here for simplicity.

At step 401, a second input operation is obtained.

Here, the second input operation is similar to the first input operation in the above first embodiment and the description thereof will be omitted here.

At step 402, when position information of the second input operation satisfies a first preset condition, a first set of icons corresponding to the position information of the second input operation is determined.

The steps 401-402 of the fourth embodiment correspond to the steps 301-302 of the third embodiment, respectively. Hence, the steps 401-402 in the fourth embodiment can be understood by those skilled in the art with reference to the above third embodiment and the description thereof will be omitted here for simplicity.

At step 403, page information for the first set of icons is obtained and displayed in the first region of the display interface.

At step 404, all the icons in the first set of icons are displayed in the second region of the display interface in accordance with the standard parameter. The first region of the display interface and the second region of the display interface are displayed in parallel with each other.

With the solution according to the embodiment of the present disclosure, when a folder is opened, it enters a folder list display mode where the folder is presented in a queue. When there are too many icons in the folder, i.e., when the number of icons in the folder is larger than the first number, the icons in the folder are scaled down such that all the icons in the folder can be displayed within one page. When the user clicks a blank region, the icons are switched to their normal size (i.e., displayed in accordance with the standard parameter) and the corresponding page content (page information) is displayed.

### Fifth Embodiment

Based on the above first embodiment, a method for display control is provided according to an embodiment of the present disclosure. The method is applied in an electronic device. The method can be implemented by a processor in the electronic device executing program codes. The program codes can be stored in a computer storage medium. That is, the electronic device includes at least the processor and the storage medium.

In an embodiment of the present disclosure, the standard parameter includes a first area, which is an area of a display region of each icon, and a first number, which is a number of icons displayed on the display interface, i.e., the number of icons that can be displayed within one page in a folder.

In an embodiment of the present disclosure, the display interface includes a first region and a second region. Referring to FIG. 1E, the first region is the region marked as S0 and the second region is the region marked as S1. The first region is used for displaying the name of a folder and the second region is used for displaying icons in the folder.

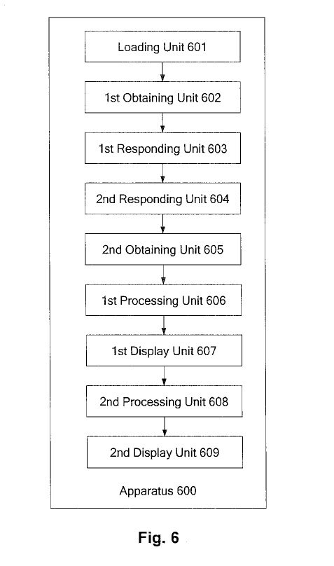

FIG. 5 is a flowchart illustrating a method for display control according to a fifth embodiment of the present disclosure. As shown in FIG. 5, the method for display control includes the following steps.

Steps 101-108 as described above.

At step 109, the plurality of icons included in each folder are displayed on the display interface associated with the folder in accordance with the specific parameter.

The steps 101-109 of the fifth embodiment correspond to the steps 101-109 of the first embodiment, respectively. Hence, the steps 101-109 in the fifth embodiment can be understood by those skilled in the art with reference to the above first embodiment and the description thereof will be omitted here for simplicity.

At step 501, a second input operation is obtained.

Here, the second input operation is similar to the first input operation in the above first embodiment and the description thereof will be omitted here.

At step 502, when the position information of the second input operation satisfies a second preset condition, a first icon corresponding to the position information of the second input operation is determined.

Here, the second condition is similar to the first condition and can be set by those skilled in the art depending on actual situations, and thus the description thereof will be omitted here.

At step 503, a first application associated with the first icon is activated.

At step 504, while the first application is being loaded, path information of the first icon is obtained.

Here, the path information enables the user to view the name of the folder to which the application belongs, which allows a new user to quickly get familiar with the desktop layout of the icons. In an implementation, the path information can be displayed in an animation. In this case, in order to provide a good view, the region for presenting the path information is not limited to the first region, but can also be presented in the second region.

At step 505, the path information of the first icon is displayed in the first region of the display interface.

At step 506, the display region of the first application is switched from the second region of the display interface to the full screen.

In an embodiment of the present disclosure, the method further includes the following steps prior to activating the first application.

At step 507, the first set of icons corresponding to the position information of the second input operation is determined.

At step 508, all the icons in the first set of icons are displayed on the display interface in accordance with the standard parameter.

The above steps 501 and 508 (in fact, the solution given in the steps 501-506) can be combined with the solution in the third embodiment. The icons can be switched back to their page in accordance with the standard parameter and then the associated application can be activated. While the application is being loaded, the icons are switched to the display region on the folder display interface and then to the full screen.

With the solution according to the embodiment of the present disclosure, when a folder is opened, it enters a folder list display mode where the folder is presented in a queue. When there are too many icons in the folder, i.e., when the number of icons in the folder is larger than the first number, the icons in the folder are scaled down such that all the icons in the folder can be displayed within one page. When the position information of the user click satisfies the second condition, the icons are first switched to their normal size (i.e., displayed in accordance with the standard parameter) and the corresponding page content (page information) is displayed. Then, the associated application is activated. In this way, the solution according to the embodiment of the present application allows the user to quickly browse and search for the content he/she desires in all the folders.

With the solution according to the embodiment of the present disclosure, the desktop application enters a folder list mode. When the user clicks an icon, the associated application is activated. While the application is being loaded, an animation is played. The presentation of the application starts at the icon, and may pause when it reaches the display range of the folder to allow the user to view the name of the folder to which the application belongs, and continues until the application activation animation occupies the entire screen to start the operation of the application itself. Conventionally, after an application is activated, the user often has to wait for a period of time while the application is being loaded, during which no useful information is presented, which results in a degraded user experience. The above solution is advantageous in that the application activation animation enables the user to view the name of the folder to which the application belongs, which allows a new user to quickly get familiar with the desktop layout of the icons.

### Sixth Embodiment

Based on the above first embodiment, an apparatus for display control is provided according to an embodiment of the present disclosure. The apparatus includes a loading unit, a first obtaining unit, a first responding unit, a second responding unit, a second obtaining unit, a first processing unit, a first display unit, a second processing unit and a second display unit, all of which can be implemented with a processor in an electronic device or specific logic circuits. In an implementation, the processor can be a Central Processing Unit (CPU), a Micro-Processor Unit (MPU), a Digital Signal Processor (DSP) or a Field Programmable Gate Array (FPGA).

FIG. 6 is a block diagram showing a structure of an apparatus for display control according to a sixth embodiment of the present disclosure. As shown in FIG. 6, the apparatus 600 includes a loading unit 601, a first obtaining unit 602, a first responding unit 603, a second responding unit 604, a second obtaining unit 605, a first processing unit 606, a first display unit 607, a second processing unit 608 and a second display unit 609.

The loading unit 601 is configured to load a desktop application. The desktop application has an interaction interface including a plurality of folders and displayed on a display screen of an electronic device.

The first obtaining unit 602 is configured to obtain a first input operation on an icon of a first folder on the interaction interface currently displayed on the display screen.

The first responding unit 603 is configured to generate, in response to the first input operation, an invocation instruction for activating a folder manager.

The second responding unit 604 is configured to activate the folder manager in response to the invocation instruction.

The second obtaining unit 605 is configured to obtain all folders in the electronic device with the folder manager.

The first processing unit 606 is configured to set all the folders to an unfolded state.

The first display unit 607 is configured to display the folders in the unfolded state in a queue on the display screen.

The second processing unit 608 is configured to process, when a plurality of icons included in each of all the folders cannot be displayed within one page on a display interface associated with each of all the folders in accordance with a standard parameter, the plurality of icons into a specific parameter based on the standard parameter. The specific parameter enables each of all the folders to display all the icons it includes within one page on its display interface.

The second display unit 609 is configured to display the plurality of icons included in each folder on the display interface associated with the folder in accordance with the specific parameter.

### Seventh Embodiment

Based on the above first embodiment, an apparatus for display control is provided according to an embodiment of the present disclosure. The apparatus includes a loading unit, a first obtaining unit, a first responding unit, a second responding unit, a second obtaining unit, a first processing unit, a first display unit, a second processing unit (including modules) and a second display unit, all of which can be implemented with a processor in an electronic device or specific logic circuits. In an implementation, the processor can be a Central Processing Unit (CPU), a Micro-Processor Unit (MPU), a Digital Signal Processor (DSP) or a Field Programmable Gate Array (FPGA).

In an embodiment of the present disclosure, the standard parameter includes a first area which is an area of a display region of each icon, and a first number which is a number of icons displayed on the display interface, i.e., the number of icons that can be displayed within one page in a folder.

The apparatus includes a loading unit, a first obtaining unit, a first responding unit, a second responding unit, a second obtaining unit, a first processing unit, a first display unit, a second processing unit and a second display unit. The second processing unit includes a first obtaining module, a first determining module and a second determining module.

The loading unit is configured to load a desktop application. The desktop application has an interaction interface including a plurality of folders and displayed on a display screen of an electronic device.

The first obtaining unit is configured to obtain a first input operation on an icon of a first folder on the interaction interface currently displayed on the display screen.

The first responding unit is configured to generate, in response to the first input operation, an invocation instruction for activating a folder manager.

The second responding unit is configured to activate the folder manager in response to the invocation instruction.

The second obtaining unit is configured to obtain all folders in the electronic device with the folder manager.

The first processing unit is configured to set all the folders to an unfolded state.

The first display unit is configured to display the folders in the unfolded state in a queue on the display screen.

The first obtaining module is configured to obtain, when a plurality of icons included in each of all the folders cannot be displayed within one page on a display interface associated with each of all the folders in accordance with a standard parameter, a number, M, of icons in a first folder, where M is an integer larger than or equal to zero.

The first determining module is configured to determine a first ratio based on the first number and M.

The second determining module is configured to determine the specific parameter based on the first ratio and the first area.

Here, the specific parameter enables each of all the folders to display all the icons it includes within one page on its display interface.

The second display unit is configured to display the plurality of icons included in each folder on the display interface associated with the folder in accordance with the specific parameter.

It is to be noted here that the description of the above apparatus embodiment is similar to the description of the above method embodiments. The apparatus embodiment has similar advantageous effects with those of the method embodiments and thus the description thereof will be omitted here. For those technical details not mentioned in the above apparatus embodiment, reference can be made to the description of the above method embodiments and the description thereof will be omitted here for simplicity.

### Eighth Embodiment

Based on the above embodiments, an apparatus for display control is provided according to an embodiment of the present disclosure. The apparatus includes a loading unit, a first obtaining unit, a first responding unit, a second responding unit, a second obtaining unit, a first processing unit, a first display unit, a second processing unit, a second display unit, a third obtaining unit, a determining unit and a third display unit, all of which can be implemented with a processor in an electronic device or specific logic circuits. In an implementation, the processor can be a Central Processing Unit (CPU), a Micro-Processor Unit (MPU), a Digital Signal Processor (DSP) or a Field Programmable Gate Array (FPGA).

In an embodiment of the present disclosure, the standard parameter includes a first area which is an area of a display region of each icon, and a first number which is a number of icons displayed on the display interface, i.e., the number of icons that can be displayed within one page in a folder.

The apparatus includes a loading unit, a first obtaining unit, a first responding unit, a second responding unit, a second obtaining unit, a first processing unit, a first display unit, a second processing unit, a second display unit, a third obtaining unit, a determining unit and a third display unit.

The loading unit is configured to load a desktop application. The desktop application has an interaction interface including a plurality of folders and displayed on a display screen of an electronic device.

The first obtaining unit is configured to obtain a first input operation on an icon of a first folder on the interaction interface currently displayed on the display screen.

The first responding unit is configured to generate, in response to the first input operation, an invocation instruction for activating a folder manager.

The second responding unit is configured to activate the folder manager in response to the invocation instruction.

The second obtaining unit is configured to obtain all folders in the electronic device with the folder manager.

The first processing unit is configured to set all the folders to an unfolded state.

The first display unit is configured to display the folders in the unfolded state in a queue on the display screen.

The second processing unit is configured to process, when a plurality of icons included in each of all the folders cannot be displayed within one page on a display interface associated with each of all the folders in accordance with a standard parameter, the plurality of icons into a specific parameter based on the standard parameter.

Here, the specific parameter enables each of all the folders to display all the icons it includes within one page on its display interface.

The second display unit is configured to display the plurality of icons included in each folder on the display interface associated with the folder in accordance with the specific parameter.

The third obtaining unit is configured to obtain a second input operation.

The first determining unit is configured to determine, when position information of the second input operation satisfies a first preset condition, a first set of icons corresponding to the position information of the second input operation.

The third display unit is configured to display all icons in the first set of icons on the display interface in accordance with the standard parameter.

It is to be noted here that the description of the above apparatus embodiment is similar to the description of the above method embodiments. The apparatus embodiment has similar advantageous effects with those of the method embodiments and thus the description thereof will be omitted here. For those technical details not mentioned in the above apparatus embodiment, reference can be made to the description of the above method embodiments and the description thereof will be omitted here for simplicity.

### Ninth Embodiment

Based on the above embodiments, an apparatus for display control is provided according to an embodiment of the present disclosure. The apparatus includes a loading unit, a first obtaining unit, a first responding unit, a second responding unit, a second obtaining unit, a first processing unit, a first display unit, a second processing unit, a second display unit, a third obtaining unit, a determining unit and a third display unit, all of which can be implemented with a processor in an electronic device or specific logic circuits. In an implementation, the processor can be a Central Processing Unit (CPU), a Micro-Processor Unit (MPU), a Digital Signal Processor (DSP) or a Field Programmable Gate Array (FPGA).

In an embodiment of the present disclosure, the standard parameter includes a first area which is an area of a display region of each icon, and a first number which is a number of icons displayed on the display interface, i.e., the number of icons that can be displayed within one page in a folder.

The apparatus includes a loading unit, a first obtaining unit, a first responding unit, a second responding unit, a second obtaining unit, a first processing unit, a first display unit, a second processing unit, a second display unit, a third obtaining unit, a determining unit, a third display unit, a fourth obtaining unit and a fourth display unit.

The loading unit is configured to load a desktop application. The desktop application has an interaction interface including a plurality of folders and displayed on a display screen of an electronic device.

The first obtaining unit is configured to obtain a first input operation on an icon of a first folder on the interaction interface currently displayed on the display screen.

The first responding unit is configured to generate, in response to the first input operation, an invocation instruction for activating a folder manager.

The second responding unit is configured to activate the folder manager in response to the invocation instruction.

The second obtaining unit is configured to obtain all folders in the electronic device with the folder manager.

The first processing unit is configured to set all the folders to an unfolded state.

The first display unit is configured to display the folders in the unfolded state in a queue on the display screen.

The second processing unit is configured to process, when a plurality of icons included in each of all the folders cannot be displayed within one page on a display interface associated with each of all the folders in accordance with a standard parameter, the plurality of icons into a specific parameter based on the standard parameter.

Here, the specific parameter enables each of all the folders to display all the icons it includes within one page on its display interface.

The second display unit is configured to display the plurality of icons included in each folder on the display interface associated with the folder in accordance with the specific parameter.

The third obtaining unit is configured to obtain a second input operation.

The first determining unit is configured to determine, when position information of the second input operation satisfies a first preset condition, a first set of icons corresponding to the position information of the second input operation.

The fourth obtaining unit is configured to obtain page information for the first set of icons.

The fourth display unit is configured to display the page information for the first set of icons in a first region of the display interface.

The third display unit is configured to display all the icons in the first set of icons in a second region of the display interface in accordance with the standard parameter. The first region of the display interface and the second region of the display interface are displayed in parallel with each other.

It is to be noted here that the description of the above apparatus embodiment is similar to the description of the above method embodiments. The apparatus embodiment has similar advantageous effects with those of the method embodiments and thus the description thereof will be omitted here. For those technical details not mentioned in the above apparatus embodiment, reference can be made to the description of the above method embodiments and the description thereof will be omitted here for simplicity.

### Tenth Embodiment

Based on the above embodiments, an apparatus for display control is provided according to an embodiment of the present disclosure. The apparatus includes a loading unit, a first obtaining unit, a first responding unit, a second responding unit, a second obtaining unit, a first processing unit, a first display unit, a second processing unit and a second display unit, all of which can be implemented with a processor in an electronic device or specific logic circuits. In an implementation, the processor can be a Central Processing Unit (CPU), a Micro-Processor Unit (MPU), a Digital Signal Processor (DSP) or a Field Programmable Gate Array (FPGA).

In an embodiment of the present disclosure, the standard parameter includes a first area which is an area of a display region of each icon, and a first number which is a number of icons displayed on the display interface, i.e., the number of icons that can be displayed within one page in a folder.

The apparatus includes a loading unit, a first obtaining unit, a first responding unit, a second responding unit, a second obtaining unit, a first processing unit, a first display unit, a second processing unit, a second display unit, a second determining unit, an activating unit, a fifth obtaining unit, a fifth display unit and a switching unit.

The loading unit is configured to load a desktop application. The desktop application has an interaction interface including a plurality of folders and displayed on a display screen of an electronic device.

The first obtaining unit is configured to obtain a first input operation on an icon of a first folder on the interaction interface currently displayed on the display screen.

The first responding unit is configured to generate, in response to the first input operation, an invocation instruction for activating a folder manager.

The second responding unit is configured to activate the folder manager in response to the invocation instruction.

The second obtaining unit is configured to obtain all folders in the electronic device with the folder manager.

The first processing unit is configured to set all the folders to an unfolded state.

The first display unit is configured to display the folders in the unfolded state in a queue on the display screen.

The second processing unit is configured to process, when a plurality of icons included in each of all the folders cannot be displayed within one page on a display interface associated with each of all the folders in accordance with a standard parameter, the plurality of icons into a specific parameter based on the standard parameter.

Here, the specific parameter enables each of all the folders to display all the icons it includes within one page on its display interface.

The second display unit is configured to display the plurality of icons included in each folder on the display interface associated with the folder in accordance with the specific parameter.

The third obtaining unit is configured to obtain a second input operation.

The second determining unit is configured to determine, when the position information of the second input operation satisfies a second preset condition, a first icon corresponding to the position information of the second input operation.

The activating unit is configured to activate a first application associated with the first icon.

The fifth obtaining unit is configured to obtain path information of the first icon while the first application is being loaded.

The fifth display unit is configured to display the path information of the first icon in a first region of the display interface.

The switching unit is configured to switch the display region of the first application from a second region of the display interface to the full screen.

In an embodiment of the present disclosure, the electronic device further includes a determining unit and a third display unit.

The first determining unit is configured to determine the first set of icons corresponding to the position information of the second input operation.

The third display unit is configured to display all the icons in the first set of icons in a second region of the display interface in accordance with the standard parameter.

It is to be noted here that the description of the above apparatus embodiment is similar to the description of the above method embodiments. The apparatus embodiment has similar advantageous effects with those of the method embodiments and thus the description thereof will be omitted here. For those technical details not mentioned in the above apparatus embodiment, reference can be made to the description of the above method embodiments and the description thereof will be omitted here for simplicity.

### Eleventh Embodiment

Based on the above embodiments, an electronic device is provided according to an embodiment of the present disclosure. The electronic device includes a display screen configured to display a display interface of a folder. The electronic device further includes a processor configured to:

load a desktop application, the desktop application having an interaction interface including a plurality of folders and displayed on the display screen of the electronic device;

obtain a first input operation on a first folder icon on the interaction interface currently displayed on the display screen;

generate, in response to the first input operation, an invocation instruction for activating a folder manager;

activate the folder manager in response to the invocation instruction;

obtain all folders in the electronic device with the folder manager;

set all the folders to an unfolded state;

display the folders in the unfolded state in a queue on the display screen;

process, when a plurality of icons included in each of all the folders cannot be displayed within one page on a display interface associated with each of all the folders in accordance with a standard parameter, the plurality of icons into a specific parameter based on the standard parameter, the specific parameter enabling each of all the folders to display all the icons it includes within one page on its display interface; and

display the plurality of icons included in each folder on the display interface associated with the folder in accordance with the specific parameter.

It is to be noted here that the description of the above electronic device embodiment is similar to the description of the above method embodiments. The electronic device embodiment has similar advantageous effects with those of the method embodiments and thus the description thereof will be omitted here. For those technical details not mentioned in the above electronic device embodiment, reference can be made to the description of the above method embodiments and the description thereof will be omitted here for simplicity.

It is to be noted that the term “one embodiment” or “an embodiment” as used throughout the description means that the specific features, structures or characteristics associated with the embodiment are included in at least one embodiment of the present disclosure. Hence, the expression “in one embodiment” or “in an embodiment” as used throughout the description does not necessarily refer to the same embodiment. Further, these specific features, structures or characteristics can be arbitrarily combined in one or more embodiments as appropriate. It should be appreciated that, in various embodiments of the present disclosure, the numbering of the above processes does not mean the order in which they are executed. The order in which the processes are executed should be determined by their functions and internal logics, rather than being limited to any embodiment of the present disclosure. The numbering of the above embodiments is used for the purpose of illustration only, but does not imply any preference among those embodiments.

It is to be noted here that the terms “including” or “comprising” or any variants thereof as used herein are not exclusive, such that a process, method, article or apparatus including/comprising a number of elements may also include/comprise other elements that are not explicitly listed or inherent to the process, method, article or apparatus. If not limited otherwise, an element included in process, method, article or apparatus does not exclude a situation where the process, method, article or apparatus including the element further includes one or more identical elements.

It can be appreciated from the embodiments of the present disclosure that the disclosed method, apparatus and electronic device can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

It can be appreciated by those skilled in the art that some or all of the steps in the method embodiments as described above can be implemented by hardware following instructions of a program. Such program can be stored in a computer readable storage medium and, when executed, performs the steps of the above method embodiments. The storage medium may be any of various mediums capable of storing program codes, such as a mobile storage device, a Read Only Memory (ROM), a Random Access Memory (RAM), a magnetic disk or an optical disc.

Alternatively, when the above integrated units of the present disclosure are implemented in software functional modules and sold or used as a standalone product, they can be stored in a computer readable storage medium. In view of this, the technical solutions according to the embodiments of the present disclosure, or in other words a part thereof which makes contribution over the prior art, can be substantially embodied in a form of software product. The computer software product can be stored in a storage medium, such as ROM/RAM, magnetic disk, optical disc and the like, containing instructions which cause a computer device (which can be a personal computer, a server, a network device or the like) to perform one or more methods according to the embodiments of the present disclosure or particular parts thereof. The storage medium may be any of various mediums capable of storing program codes, such as a mobile storage device, a ROM, a RAM, a magnetic disk or an optical disc.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

What is claimed is:

1. A method for display control, comprising:
loading a desktop application having an interaction interface, wherein the interaction interface includes a plurality of folders and is displayed on a display screen of an electronic device;
obtaining a first input operation on an icon of a first folder in the interaction interface currently displayed on the display screen;
generating, in response to the first input operation, an invocation instruction for activating a folder manager;
activating the folder manager in response to the invocation instruction;
obtaining all folders in the electronic device with the folder manager;
setting all the folders to an unfolded state; and
displaying the folders in the unfolded state in a queue on the display screen.

2. The method of claim 1, further comprising:
processing, when a plurality of icons included in each of the folders cannot be displayed in accordance with a standard parameter within one page on a display interface associated with each of the folders, the plurality of icons to obtain a specific parameter based on the standard parameter, the specific parameter enabling all the icons included in each of the folders to be displayed within one page on the associated display interface of the folder; and
displaying, in accordance with the specific parameter, the plurality of icons included in each of the folders on the display interface associated with the folder.

3. The method of claim 2, wherein the standard parameter comprises a first area which is an area of a display region for each icon, and a first number which is a number of icons to be displayed on the display interface, and wherein said processing the plurality of icons to obtain the specific parameter based on the standard parameter comprises:
obtaining a number, M, of icons in a first folder, where M is an integer larger than or equal to zero;
determining a first ratio based on the first number and M; and
determining the specific parameter based on the first ratio and the first area.

4. The method of claim 1, further comprising:
obtaining a second input operation;
determining, when position information of the second input operation satisfies a first preset condition, a first set of icons corresponding to the position information of the second input operation; and
displaying all icons in the first set of icons on the display interface in accordance with the standard parameter.

5. The method of claim 4, further comprising:
obtaining page information for the first set of icons; and
displaying the page information for the first set of icons in a first region of the display interface, and
wherein said displaying all icons in the first set of icons on the display interface in accordance with the standard parameter comprises:
displaying all the icons in the first set of icons in a second region of the display interface in accordance with the standard parameter, the first region of the display interface and the second region of the display interface being displayed in parallel.

6. The method of claim 4, further comprising:
determining, when the position information of the second input operation satisfies a second preset condition, a first icon corresponding to the position information of the second input operation;
activating a first application associated with the first icon;
obtaining path information of the first icon while the first application is being loaded;
displaying the path information of the first icon in a first region of the display interface; and
switching the display region of the first application from a second region of the display interface to the full screen.

7. The method of claim 6, further comprising, prior to activating the first application:
determining the first set of icons corresponding to the position information of the second input operation; and
displaying all the icons in the first set of icons on the display interface in accordance with the standard parameter.

8. An apparatus for display control, comprising:
a loading unit configured to load a desktop application having an interaction interface, wherein the interaction interface includes a plurality of folders and is displayed on a display screen of an electronic device;
a first obtaining unit configured to obtain a first input operation on an icon of a first folder on the interaction interface currently displayed on the display screen;
a first responding unit configured to generate, in response to the first input operation, an invocation instruction for activating a folder manager;
a second responding unit configured to activate the folder manager in response to the invocation instruction;
a second obtaining unit configured to obtain all folders in the electronic device with the folder manager;
a first processing unit configured to set all the folders to an unfolded state; and
a first display unit configured to display the folders in the unfolded state in a queue on the display screen.

9. The apparatus of claim 8, further comprising:
a second processing unit configured to process, when a plurality of icons included in each of the folders cannot be displayed in accordance with a standard parameter within one page on a display interface associated with each of the folders, the plurality of icons to obtain a specific parameter based on the standard parameter, the specific parameter enabling all the icons included in each of the folders to be displayed within one page on the associated display interface of the folder; and
a second display unit configured to display, in accordance with the specific parameter, the plurality of icons included in each of the folders on the display interface associated with the folder.

10. The apparatus of claim 9, wherein the standard parameter comprises a first area which is an area of a display region for each icon, and a first number which is a number of icons to be displayed on the display interface, and wherein the second processing unit comprises:
a first obtaining module configured to obtain a number, M, of icons in a first folder, where M is an integer larger than or equal to zero;
a first determining module configured to determine a first ratio based on the first number and M; and
a second determining module configured to determine the specific parameter based on the first ratio and the first area.

11. The apparatus of claim 8, further comprising:
a third obtaining unit configured to obtain a second input operation;
a first determining unit configured to determine, when position information of the second input operation satisfies a first preset condition, a first set of icons corresponding to the position information of the second input operation; and
a third display unit configured to display all icons in the first set of icons on the display interface in accordance with the standard parameter.

12. An electronic device, comprising:
a display screen configured to display a display interface for a folder; and
a processor configured to:
load a desktop application having an interaction interface, wherein the interaction interface includes a plurality of folders and is displayed on the display screen of the electronic device;
obtain a first input operation on a first folder icon on the interaction interface currently displayed on the display screen;
generate, in response to the first input operation, an invocation instruction for activating a folder manager;
activate the folder manager in response to the invocation instruction;
obtain all folders in the electronic device with the folder manager;
set all the folders to an unfolded state; and
display the folders in the unfolded state in a queue on the display screen.

13. The electronic device of claim 12, wherein the processor is further configured to:
process, when a plurality of icons included in each of the folders cannot be displayed in accordance with a standard parameter within one page on a display interface associated with each of the folders, the plurality of icons to obtain a specific parameter based on the standard parameter, the specific parameter enabling all the icons included in each of the folders to be displayed within one page on the associated display interface of the folder; and
display, in accordance with the specific parameter, the plurality of icons included in each of the folders on the display interface associated with the folder.
